(19) United States
(12) Patent Application Publication
(10) Pub. No.: US 2003/0040934 A1
(43) Pub. Date: Feb. 27, 2003

(54) Integrated home inspection and home warranty system

(76) Inventors: Brent Skidmore, Greenville, SC (US); David Wayne Sumner, Greenville, SC (US)

Correspondence Address: MCNAIR LAW FIRM, P.O. BOX 10827, GREENVILLE, SC, 29603-0827, US

(21) Appl. No.: 10/202,596

(22) Filed: Jul. 24, 2002

Related U.S. Application Data
(60) Provisional application No. 60/314,462, filed on Aug. 23, 2001.

(51) Int. Cl. G06F 17/60; G06F 17/00

(52) U.S. Cl. 705/1; 707/104.1

(57) ABSTRACT

This invention is directed to the automated generation of a home inspection report according to home inspection information gathered from a home inspector during the inspection of a home. Also, this invention is directed to the subsequent creation of a home warranty insurance policy created according to the home inspection information so that a customized home warranty inspection policy based upon the home inspection information is provided.

### FIELD OF THE INVENTION

The present invention is directed to a computerized home inspection and home warranty underwriting system and method, in particular, to a system and method for collecting information from a physical home inspection, formatting the results into a report allowing secured access to the results of the inspection, and transmitting the results to a home warranty underwriting system for automated customization of home warranty insurance policies. This application claims priority of provisional patent application Serial No. 60/314,462, filed on Aug. 23, 2001.

### BACKGROUND OF THE INVENTION

The purchase of a home is usually the largest single investment the average person makes. As such, buyer should learn as much as they can about the condition of the property, particularly the need for any major repairs prior to purchasing the home. It is the buyer who should attempt to reduce the risk of the purchase since, generally, the “buyer beware” doctrine applies to these situations. One way to reduce the risks of purchasing a home is to have a home inspection performed. A home inspection is a tool used to assure buyers that the home they are about to purchase is in an acceptable condition. Therefore, a home inspection is an integral part of the home buying process. Inspections are requested by buyers either before they purchase or by sellers as they are preparing to sell. From a home inspection, an opinion is formed based upon objective criteria applied to the physical observations of the house. Traditionally, the process involves recording results and opinions from the inspection onto paper forms. The inspection process itself involves a physical inspection from the foundation to the roof. Only someone with knowledge of home construction, installation, maintenance and other home systems should perform the inspection to insure that a proper home inspection was conducted. Additionally, each inspector should follow a checklist to insure that all aspects of the inspection were performed and none were forgotten. Traditionally, paper forms show what should be inspected and provided a checklist, but little or no instruction is provided to assist the inspector in how to perform the inspection.

Paper forms are submitted to the party that requested the home inspection, traditionally used to determine the present condition of the home. In order to provide this information to a buyer, seller, or real estate agents, a copy of the form must be physically transmitted to each person. This process delays the purchase cycle as the parties await their individual copy of the inspection.

While home inspection does assist in reducing the risk associated with purchasing a home, it is certainly not the only means. One other method of reducing risk when buying a home is for the buyer to purchase a home warranty insurance policy. A home warranty is an insurance policy designed to protect against repair and maintenance of a home. Generally, the home warranty industry writes “blanket” home warranty policies without the ability to tailor each policy to the specific conditions of the home. For instance, two homes will be similar in size and location and therefore could have a similar policy. However, if one home has a brand new roof, and the other home has a twenty-year-old roof, then the risks associated with the two homes are substantially different. These differences, however, are not reflected in the policies. Additionally, it is common for a home warranty to exclude coverage under a “pre-existing condition” clause so that the home warranty is of little value. These exclusions are used to give the underwriter the ability to deny claims based upon the condition of the home. Unfortunately, the home purchaser may not know what is considered a “pre-existing condition” to the policy underwriter.

Unfortunately, the present underwriting system does not consider the separate investigation of each individual home but must aggregate risk across all policies. Therefore, policy purchaser with a home in good repair is either paying higher premiums or not receiving the maximum coverage allowable. A system allowing the customization of a home warranty to the condition of each specific home is a problem where significant attention need be directed.

Accordingly, it is an object of the present invention to create a home inspection system with the ability to provide the inspection results to inspectors, realtors, buyers and sellers quickly and easily.

It is yet another object of the present invention to create a system that allows inspection information to be used to creating a home warranty insurance policy for creating customized policies for each home.

### SUMMARY OF THE INVENTION

The above objects are achieved by providing a system for recording home inspection observations, for at least one home inspection item, made by a home inspector and providing home warranty information. The system includes a computer readable medium having a set of computer readable instructions for receiving inspection information representing the observations of a home inspection, formatting the inspection information into a predetermined format, such as a template, form, graphical user interface, spreadsheet, table, or other format, to provide a report containing the inspection observations, and creating warranty information according to the inspection information so that a home warranty policy can be created according to the home warranty information. The computer readable medium may be in communication with a communications network with the set of computer readable instructions including instructions for transmitting the formatted inspection information to a recipient through the communications network. The communications network may be a global communications network. The computer readable instructions may include instructions for transmitting the inspection information in an electronic format. The set of computer readable instructions may also include instructions for creating a home warranty insurance policy according to the home warranty information. The set of computer readable instructions may also include instructions for transmitting the home warranty insurance policy to a recipient through the communications network. The home warranty or home inspection information may represent whether the at least one home inspection item is in need of repair and the set of computer readable instructions may also include instructions for receiving repair information representing the repair of the at least one home inspection item. The computer instruction can update the home warranty information according to the repair information so that the home warranty policy can be created according to the warranty information after receiving the repair information. The set of computer readable instructions may also include instructions for creating correspondence to a recipient from the home inspector according to the inspection information. The set of computer readable instructions may also include instructions for: creating a home warranty insurance policy according to the home warranty information; prompting the home inspector to perform inspection steps; prompting the home inspector to record observations made according to performing the inspection steps; providing inspection steps instruction explaining the manner for conducting the inspection steps; creating an invoice representing the cost of performing a home inspection so as to inform a customer of such costs; receiving payment status representing the account of the customer requesting the home inspection; updating the account information of the customer; displaying the account so that the account of the customer is provided; receiving home inspection appointment information; organizing the home inspection appoint information according to specific home inspectors; displaying the home inspection appointment information so that the home inspector is provided with a schedule of when to perform home inspections; creating correspondence to a recipient from the home inspection information; retrieving home inspection information representing a plurality of inspected homes according to the home inspection information so that statistical information can be derived from the home inspection information; allowing the inspection information to be accessible through a communications network. The home inspection information may also include property information and the computer readable instructions may also include instructions for storing the home inspection information in the computer readable medium according to the property information so that home inspection information can subsequently be retrieved according to the property information. The set of computer readable instructions include instructions for receiving repair information for the at least one inspection item representing the repair of the at least one inspected item, updating the warranty information according to the repair information so that the home warranty policy can be created according to the home warranty information after receiving the repair information.

The objectives may also be met through the steps of performing a home inspection on a target home; recording observations from the home inspection on a computer readable medium thereby creating home inspection information; generating a home inspection report according to the home inspection information; and, providing the home inspection information so that a home warranty insurance policy can be created according to the home inspection information. There may also be a step of transmitting the home inspection report to a recipient; transmitting the home inspection report to a recipient in an electronic format over a communications network; creating a home warranty insurance policy according to the home inspection information; transmitting the home warranty insurance policy to a recipient; inspecting at least one inspection item; and, determining, for the at least one inspection item, whether the at least one inspection item needs repair so that the home inspection information includes whether at least one inspection item needs repair. There may also be steps of receiving repair information representing the repair of the at least one inspection item; updating the home inspection information according to the repair information; storing the home inspection report on a computer readable medium so that the home inspection report is accessible through a communications network; receiving home inspection information representing the inspection of at least one inspection item; creating warranty information according to the home inspection information so that a home warranty insurance policy can be created according to the home inspection information; creating a home warranty insurance policy according to the home warranty information; transmitting the home warranty insurance policy to a recipient; transmitting the home warranty insurance policy to a recipient in an electronic format over a communications network; receiving repair information for the at least one inspection item representing the repair of the at least one inspection item; updating the warranty information according to the repair information; and creating a home warranty insurance policy according to the home warranty information.

### BRIEF DESCRIPTION OF THE DRAWINGS

The invention will be more readily understood from a reading of the following specification and by reference to the accompanying drawings forming a part thereof, wherein an example of the invention is shown and wherein:

FIG. 1 is a schematic illustrating data flow between various components of this invention;

FIG. 2 is a schematic illustrating the various components of the invention;

FIG. 3 is a flowchart illustrating the functionality of this invention; and,

FIG. 4 is a flowchart illustrating the functionality of the invention.

### DETAILED DESCRIPTION OF THE PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated. An object or module is a section of computer readable code embodied in a computer readable medium that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein. The term “communications network” can include local area network, wide area network, telecommunications network, or the Internet.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks. These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

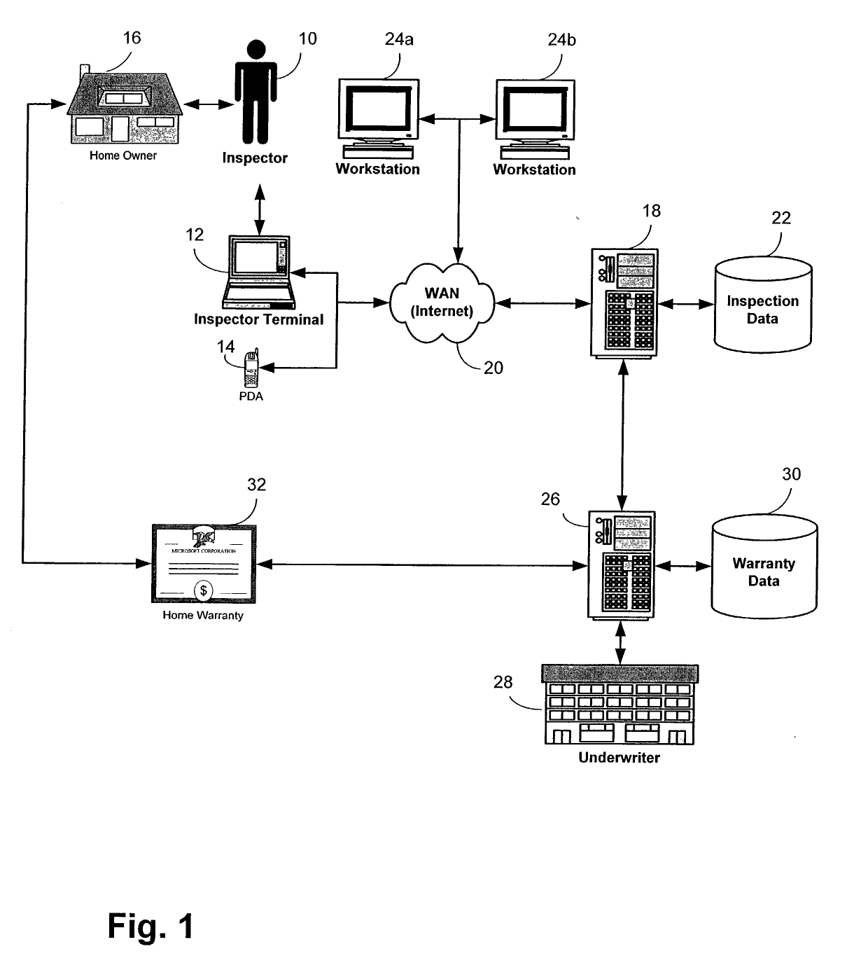

Referring now to FIG. 1, the process and data flows according to this invention are listed in further detail. In the operation of this invention in the preferred embodiment, a home inspector 10 is equipped with some form of computer readable medium such as an inspector terminal 12, a personal computer, lap top computer or personal digital assistant (PDA) 14. Paper forms can be used in an alternative embodiment. The computer readable medium embodies computer readable instructions that include both the functionality of recording home inspection observations and results as described herein, operation manuals that are integrated within the computer readable instructions for assisting an inspector in the field, and other administration functionalities such as the ability to create correspondence to a client or real estate agent, generate invoices, and update account receivable records associated with the individual or entity who ordered the home inspection. When a home inspection request is made, the target property 16 is identified and a time scheduled for the inspection. This information can be downloaded from a home office server 18 through a wide area network 20 to provide for an automated scheduling system, allowing a home inspector to know of the inspections and their location to be performed. Upon receiving the home inspection request, the home inspector arrives at the target property and performs an inspection. The results of the inspection are recorded in the computer readable medium such as inspector terminal 12 or PDA 14 and transmitted back to the server 18. Upon receiving the results of the inspection, this information can be collected and stored in an inspection database 22 for subsequent retrieval. Once stored, the results of the inspection can be available for viewing through work stations 24A and 24B through wide area network 20. This allows a multitude of individuals or entities to view the results of the inspection since it is electronically available from home server 18. Therefore, the buyer, seller or real estate agents involved can retrieve and view the results of the home inspection as soon as it is made available. This alleviates the need to mail hard copies to each party and expedites the purchase process by providing this information as soon as it is ready.

Once stored, the results from the inspection can be sent to an underwriter server 26 of underwriter 28. The underwriter can then use the results of the inspection information to “tailor” a home warranty policy based upon the inspection data received from the inspector and criteria contained within warranty data 30 of the underwriter. For example, the home inspection may reveal that there is substantial damage to the heat pump associated with the house. The underwriter, upon knowing this information, may decide not to warrant that particular appliance or may wish to adjust a premium to reflect the substantial damage to that particular appliance. By using the inspection information to derive home warranty insurance policy terms, a policy can be tailored thereby allowing a homeowner to repair the damaged items in order to reduce the premiums or exclude damaged items from coverage in order to reduce premiums so that all parties can make better decisions on a more complete set of information. Once the analysis as to underwriting is completed, the underwriter may issue a home warranty policy 32 which would reflect the items found in the home inspection and policy and now can provide more tailored coverage to the home purchaser.

In an alternative embodiment, the system can be tailored for specific inspection and warranty products rather than for complete home inspections and warranty products. For example, the system can be for inspecting a specific feature of the house such as stucco, mold, moisture issues, or other inspection items. In this embodiment, the specific inspection for the inspection item is performed, recorded, and stored in the computer readable medium. The home warranty policy can then be created according to the results of the stucco inspection so as to provide for a stucco home warranty policy.

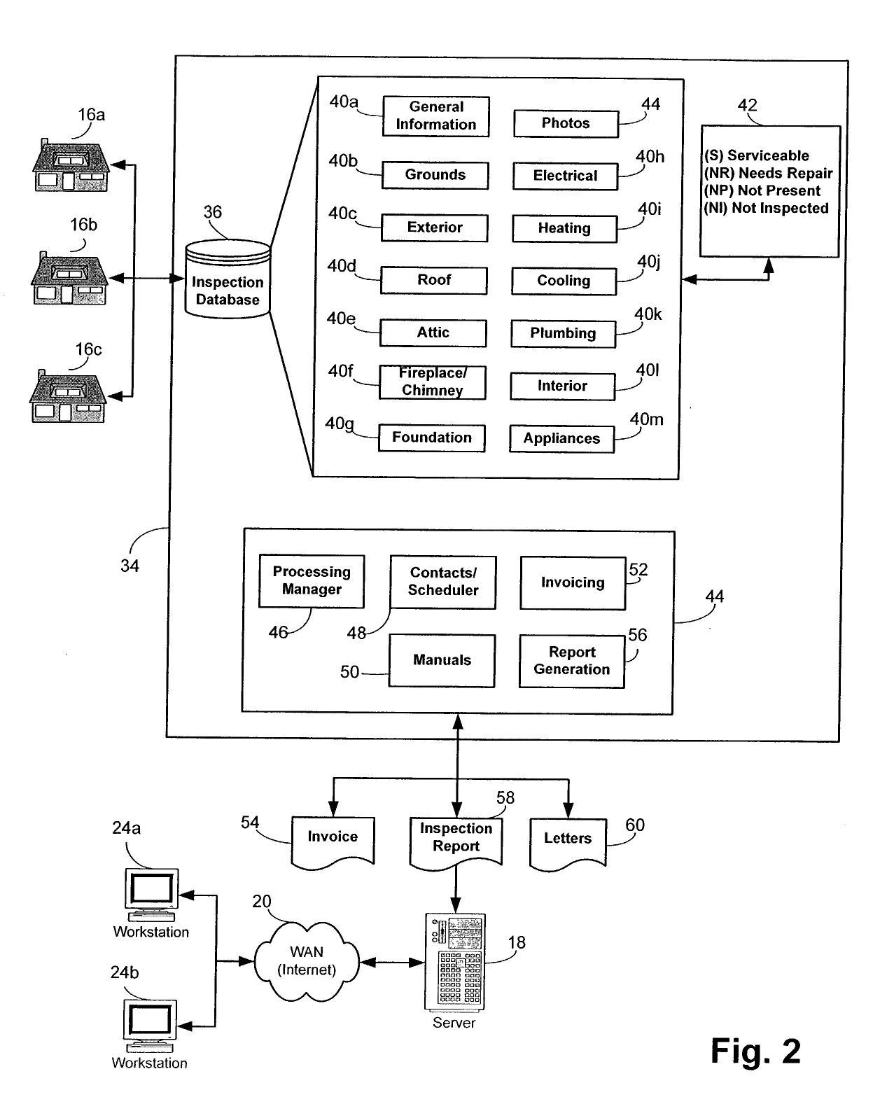

Referring now to FIG. 2, the computer readable instructions provided to the home inspector and their associated functionality are described in more detail. A computer readable medium 34 embodies computer readable instructions, which are a component of this invention. Additionally, inspection database 36 is incorporated in the computer readable medium and contains the inspection criteria to be followed by the home inspector. For example, if the home inspector were to inspect homes 16A, 16B, and 16C, the inspection database would have the results from each of those target properties. In the inspection itself, this invention records the inspection observations for each inspection item. Inspection items can include general information 40A that includes the age of the target property, the size, the address, the current owner and a visual representation, such as a photograph or digital image of the target home inspected. Inspection items concerning the grounds shown as 40B, include information concerning the grade and drainage of the property, the driveway, any outdoor lighting, and the condition of any trees and/or their associated limbs. Exterior inspection items 40C include information concerning the condition of any siding, shutters, soffits, porches, decks, windows, and garages. Roof inspection items 40D include the information concerning the roof material, the roof style, and the condition of any flashing, skylights or gutters. Attic inspection items 40E include the condition of framing, ceiling joists, ventilation and insulation. Fireplaces and chimney inspection criteria 40F with the existence of gas logs, the condition of the damper, flue liner, and chimney for each fireplace that may be located at the target property. Foundation inspection items 40G include information concerning the moisture penetration, wall material, girders, sub-floor, sump pumps for crawl spaces, ventilation, and insulation. Electrical inspection items 40H includes the condition of wiring, grounding equipment, electrical panels, electrical sub-panels, 110 volt circuits, 220 volt circuits, receptacles, lighting, fixtures and switches, and general safety concerns concerning the electrical systems. Heating inspection items 401 include the condition of the heating unit, its manufacturer, its capacity, its approximate age, and its location. Cooling inspection items 40J include information concerning the cooling unit similar to that recorded for the heating unit. For both the heating and cooling unit, information concerning the ducts or filters can also be included. Plumbing inspection items 40K includes information concerning the water supply, pipe system, wastewater disposal, plumbing fixtures, and water heater. Interior inspection items 40L include information concerning the rooms within the house, the floors and walls, any alarms, the ceiling, and any stairs or doors. Appliance inspection criteria 40M includes information concerning the appliances contained within the home such as dishwasher, washer/dryer, refrigerator, trash compactor, or microwave. For each of the inspection items, the preferred embodiment contains four categories representing the condition of the particular item being inspected. Categories 42 contain the designation, (S), representing that the particular item is serviceable. The second designation, (NR), represents that the particular item needs repair. In this case, the item must be repaired before the home inspection would show the particular item as serviceable. This information is important to the buyer as well as for the home warranty policy since an item that is in need of repair may both prevent the buyer from purchasing the home as well as preventing a home warranty policy from covering such an item. The seller would then be informed as to the item needing repair and remedial measures can be taken to hopefully move the item into a state of serviceability. The third designation, (NP), represents that the item is not present. The fourth designation, (NI), represents the fact that the item was not inspected. For these items, further inquiry must be made as to why a particular item was not inspected. In order to further illustrate the condition of the property as well as to merely identify the property itself, a photo 44 can be included with the inspection information stored in inspection database 36 so as to provide a visual representation of the inspected property.

Also contained within computer readable medium 34 are modules 44 which provide functionality of the present invention. A processing manager 46 allows for a request that is made to inspect a target property to be recorded and integrated into the information contained within this invention, When the target property is to be inspected, the contacts associated with the target property and a time when the inspection should occur is provided by the requesting party and contact scheduler module 48 allows for the recording of this information and scheduling of an inspection. By having this module embodied in the computer readable medium of the home inspector, the schedule of inspections to be performed can be automatically generated and provided to the home inspector. During the course of performing the inspection, an inspection manual 50 is also embodied in computer readable medium 34. By having a detailed manual on the operation and inspection of a target property, the home inspector has an in field, on line means for obtaining an explanation on how to inspect a particular item. For example, if a home inspector is in need of information for inspecting a heat pump, the home inspector can merely refer to the on-line manual which will give a detailed explanation of the steps to be performed and their relationship with the inspection according to that particular item. Once the inspection is complete, invoicing module 52 can generate an invoice for the inspection and can create and provide a hard copy invoice 54 according to the purchase information covered by the purchase manager and the contact information contemporaneously obtained. The report generator 56 formats the results of the inspection into a useable format to produce inspection report 58. This inspection report, both in hard and soft copy, can be transmitted to the home office server 18 and is thereby made available through wide area network 20 to work stations 24A and 24B. Associated with transmitting the invoice and inspection reports, it may be necessary to provide correspondence to the involved individuals. In this case, correspondence 60 can be generated by any of the modules before transmission to the respective entities. For example, the purchase manager may generate a “thank you” letter to be sent upon receiving an inspection order; the invoicing manager may create a cover letter to be provided with each invoice transmitted; or the report generator may generate a cover letter that accompanies the inspection report.

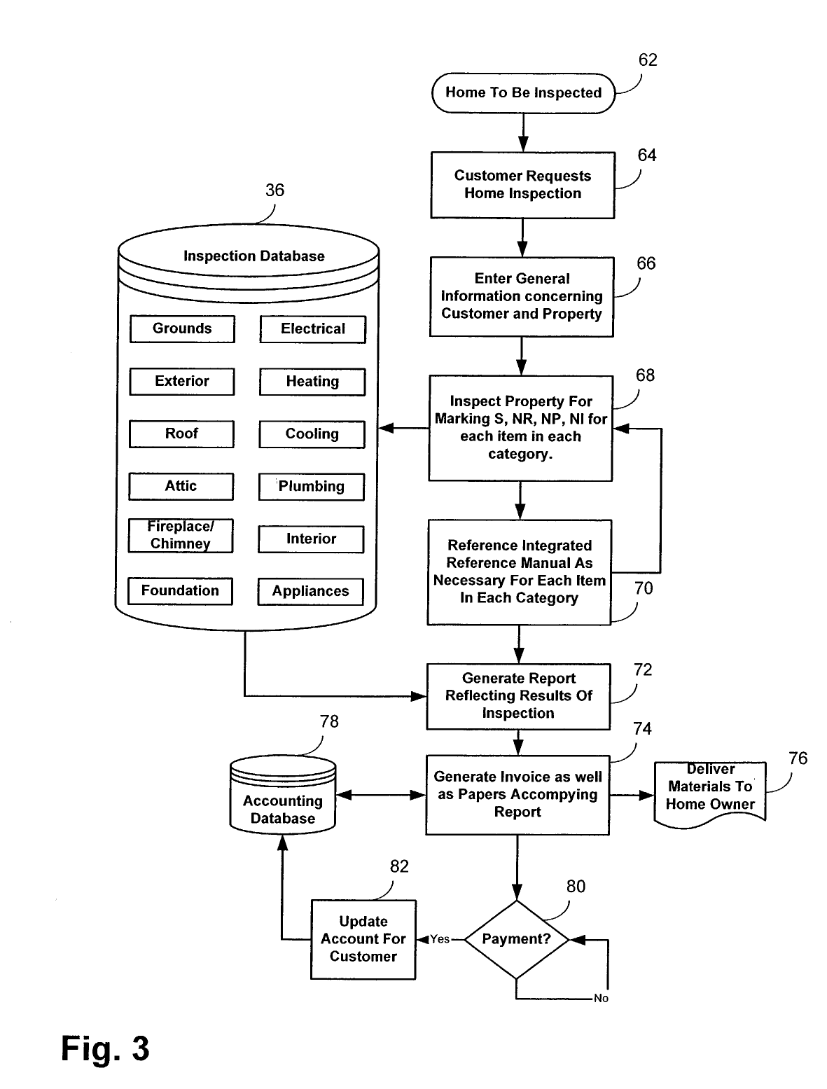

Referring now to FIG. 3, the specific steps involved in association with this invention are further illustrated. In step 62 it is known that a home needs to be inspected. Therefore, the customer requests a home inspection in step 64. General information concerning the customer and the target property are collected in step 66 and can be stored in a computer readable medium. Therefore, the customer, target property, and scheduling information can be transmitted or provided to a home inspector so as the home inspector can commence a home inspection. Thereafter, the home inspector inspects the property in step 68 and for each item contained in inspection database 36, a marking of (S), (NR), (NP) or (NI) is recorded for each item. During the course of the inspection, the home inspector may need to reference the integrated manual in step 70 for each item in each category. Upon completion of the inspection, the data for the home inspection is formatted and the report is generated in step 72. The invention may also generate an invoice in step 74 which can be delivered with the home inspection report in step 76. An entry can be made upon generation of an invoice and an accounting database 78 showing that the customer has an accounts receivable balance due the home inspector. Upon receipt of payment of the invoice in step 80, the account for the particular customer can be updated in step 82, showing a credit to the accounts receivable balance for that particular customer according to the received payment.

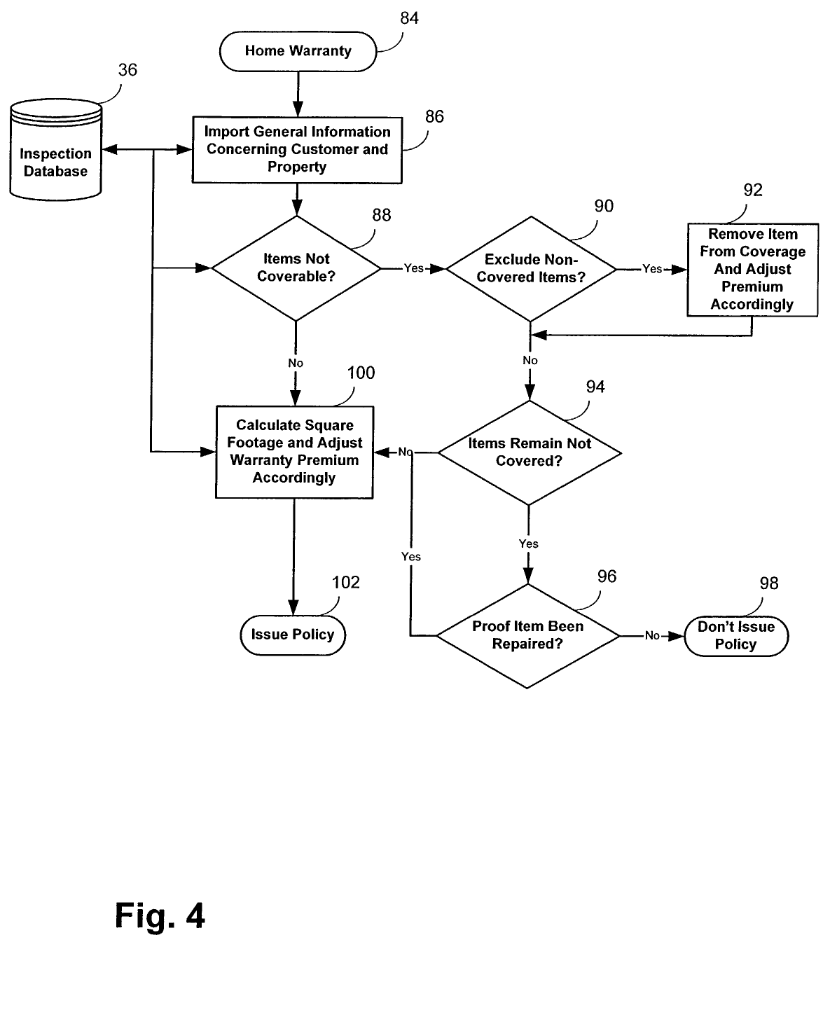

Referring now to FIG. 4, once home inspection is completed, there should be sufficient information for a home warranty underwriter to be able to provide a home warranty. A home warranty may be secured for many reasons such as the buyer wishing to reduce the risk, the seller wishing to make the property more attractive, or the real estate agent as a service to its clients. In any event, a home warranty is requested in step 84. Information concerning the customer and the target property are imported from inspection database 36 in step 86. According to the information retrieved from the inspection database concerning the target property, a determination is made in step 88 as to what items are not coverable. For example, any item that has a designation of NR, or NP, would not automatically be covered since they would be respectively in need of repair. Or not present. In the event that an item is not covered, a determination is made in step 90 as to whether to exclude that particular item from coverage. If so, the item is removed from coverage and a premium may be adjusted accordingly in step 92. If, however, an item is not coverable and is not excluded, there remains an item 6 that is not covered in step 94. In this case, there needs to be a determination made as to whether the item has been satisfactorily repaired in step 96. If not, the policy cannot be issued because there are items for which coverage would normally not apply both for which the disposition of has not been determined. However, if it is shown that the item not covered has been satisfactorily repaired, then the item can be covered and further calculations of square footage for the target property is determined and if the property's square footage is above the predetermined value, the premium can be adjusted accordingly. Once the items that have not been covered are disposed of and the additional calculations for home warranty policies are made, a policy can be issued to the homeowner in step 102.

Numerous characteristics and advantages of the invention have been set forth in the foregoing description, together with details of the structure and function of the invention, and the novel features thereof are pointed out in appended claims. The disclosure, however, is illustrative only, and changes may be made in detail, especially in matters of shape, size and arrangement of parts, within the principle of the invention, to the full extent indicated by the broad general meaning of the terms in which the appended claims are expressed.

What is claimed is:

1. A system for recording home inspection observations, for at least one home inspection item, made by a home inspector and providing home warranty information comprising:
a computer readable medium;
a set of computer readable instructions embodied within said computer readable medium for receiving inspection information representing the observations of a home inspection, formatting said inspection information into a predetermined format to provide a report containing said inspection observations, and creating warranty information according to said inspection information so that a home warranty policy can be created according to said home warranty information.

2. The system of claim 1 wherein:
said computer readable medium is in communication with a communications network;
said set of computer readable instructions include instructions for transmitting said formatted inspection information to a recipient through said communications network.

3. The system of claim 2 wherein said communications network is a global communications network.

4. The system of claim 2 wherein said computer readable instructions include instructions for transmitting said inspection information in an electronic format.

5. The system of claim 1 wherein said set of computer readable instructions include instructions for creating a home warranty insurance policy according to said home warranty information.

6. The system of claim 5 wherein:
said computer readable medium is in communication with a communications network; and,
said set of computer readable instructions include instructions for transmitting said home warranty insurance policy to a recipient through said communications network.

7. The system of claim 1 wherein:
said home warranty information represents whether said at least one home inspection item is in need of repair; and,
said set of computer readable instructions include instructions for receiving repair information representing the repair of said at least one home inspection item, and updating said home warranty information according to said repair information so that the home warranty policy can be created according to said warranty information after receiving said repair information.

8. The system of claim 7 wherein said set of computer readable instructions include instructions for creating correspondence to a recipient from said home inspector according to said inspection information.

9. The system of claim 7 wherein said set of computer readable instructions include instructions for creating a home warranty insurance policy according to said home warranty information.

10. The system of claim 1 wherein said set of computer readable instructions include instructions for prompting said home inspector to perform inspection steps, prompting said home inspector to record observations made according to performing said inspection steps, and providing inspection steps instruction explaining the manner for conducting said inspection steps.

11. The system of claim 1 wherein said computer readable instructions for creating an invoice representing the cost of performing a home inspection so as to inform a customer of such costs.

12. The system of claim 1 wherein said computer readable instructions include instructions for receiving payment status representing the account of the customer requesting said home inspection, updating said account information of the customer, and displaying the account so that the account of the customer is provided.

13. The system of claim 1 wherein said computer readable instructions include instructions for receiving home inspection appointment information, organizing said home inspection appoint information according to specific home inspectors, displaying said home inspection appointment information so that the home inspector is provided with a schedule of when to perform home inspections.

14. The system of claim 1 wherein said set of computer readable instructions include instructions for creating correspondence to a recipient from said home inspection information.

15. The system of claim 1 wherein:
said home inspection information includes property information; and,
said computer readable instructions include instructions for storing said home inspection information in said computer readable medium according to said property information so that home inspection information can subsequently be retrieved according to said property information.

16. The system of claim 1 wherein said computer readable instructions include instructions for retrieving home inspection information representing a plurality of inspected homes according to said home inspection information so that statistical information can be derived from said home inspection information.

17. The system of claim 1 wherein said computer readable instructions include instructions for allowing said inspection information to be accessible through a communications network.

18. The system of claim 1 wherein said computer readable instructions for receiving inspection information representing observations of a stucco home inspection.

19. A system for creating a home warranty insurance policy for a specific home comprising:
a computer readable medium; and,
a set of computer readable instructions embodied within said computer readable medium for receiving home inspection information, representing the inspection of at least one inspection item and creating warranty information according to said home inspection information so that a home warranty insurance policy can be created according to said home inspection information.

20. The system of claim 19 wherein said computer readable instructions include instructions for creating a home warranty insurance policy according to said home warranty information.

21. The system of claim 20 wherein:
said computer readable medium is in connection with a communications network; and,
said set of computer readable instructions include instructions for transmitting said home warranty insurance policy to a recipient through said communications network.

22. The system of claim 21 wherein said communications network is a global communications network.

23. The system of claim 19 wherein:
said home inspection information represents whether said at least one inspected item is in need of repair; and,
said set of computer readable instructions include instructions for receiving repair information for said at least one inspection item representing the repair of said at least one inspected item, updating said warranty information according to said repair information so that the home warranty policy can be created according to said home warranty information after receiving said repair information.

24. The system of claim 23 wherein said computer readable instructions include instructions for creating a home warranty insurance policy according to said home warranty information.

25. A method for performing and recording a home inspection for providing warranty information for creating a home warranty insurance policy comprising the steps of:
performing a home inspection on a target home;
recording observations from said home inspection on a computer readable medium thereby creating home inspection information;
generating a home inspection report according to said home inspection information; and,
providing said home inspection information so that a home warranty insurance policy can be created according to said home inspection information.

26. The method of claim 25 including the step of transmitting said home inspection report to a recipient.

27. The method of claim 26 including the step of transmitting said home inspection report to a recipient in an electronic format over a communications network.

28. The method of claim 25 including the step of creating a home warranty insurance policy according to said home inspection information.

29. The method of claim 28 including the step of transmitting said home warranty insurance policy to a recipient.

30. The method of claim 25 wherein:
said step of performing a home inspection includes the step of inspecting at least one inspection item; and,
determining, for said at least one inspection item, whether said at least one inspection item needs repair so that said home inspection information includes whether at least one inspection item needs repair.

31. The method of claim 30 including the steps of:
receiving repair information representing the repair of said at least one inspection item; and
updating said home inspection information according to said repair information.

32. The method of claim 25 including the steps of storing said home inspection report on a computer readable medium so that said home inspection report is accessible through a communications network.

33. A method for creating a home warranty insurance policy for a specific home comprising the steps of:
receiving home inspection information representing the inspection of at least one inspection item; and
creating warranty information according to said home inspection information so that a home warranty insurance policy can be created according to said home inspection information.

34. The method of claim 33 including the step of creating a home warranty insurance policy according to said home warranty information.

35. The method of claim 34 including the step of transmitting said home warranty insurance policy to a recipient.

36. The method of claim 33 including the step of transmitting said home warranty insurance policy to a recipient in an electronic format over a communications network.

37. The method of claim 33 including the steps of:
receiving repair information for said at least one inspection item representing the repair of said at least one inspection item; and,
dating said warranty information according to said repair information.

38. The method of claim 37 including the step of creating a home warranty insurance policy according to said home warranty information.

39. The method of claim 33 wherein said home inspection information represents the inspection of stucco.
